(19) United States
(12) Patent Application Publication
(10) Pub. No.: US 2006/0074909 A1
(43) Pub. Date: Apr. 6, 2006

(54) Automated resume evaluation system

(76) Inventor: Bradley Fredericks, Colchester, VT (US)

Correspondence Address: INSKEEP INTELLECTUAL PROPERTY GROUP, INC, 2281 W. 190TH STREET, SUITE 200, TORRANCE, CA, 90504, US

(21) Appl. No.: 11/238,950

(22) Filed: Sep. 28, 2005

Related U.S. Application Data
(60) Provisional application No. 60/614,133, filed on Sep. 28, 2004.

(51) Int. Cl. G06F 17/30

(52) U.S. Cl. 707/6

(57) ABSTRACT

In one preferred embodiment according to the present invention, an automated résumé evaluation system is provided which accepts résumés in an electronic file format, evaluates those résumés according to a predetermined set of rules, then provides correspondence based on the outcome of the predetermined rules, which is sent back to the résumé submitter. Preferably, this predetermined set of rules is based on research, interviews, and surveys into the needs and desires of potential employers and recruiters.

### CROSS-REFERENCE TO RELATED APPLICATIONS

This application claims priority to U.S. Provisional Application Ser. No. 60/614,133 filed Sep. 28, 2004 entitled Automated Résumé Evaluation System and is hereby incorporated by reference.

### BACKGROUND OF THE INVENTION

Commonly, job seekers have pursued job opportunities by submitting their résumé to prospective employers. Typically, a résumé seeks to inform a potential employer about the job seeker's skills, education, and job history.

While a job seeker may posses a skill set highly valued by potential employers, often these job seekers lack the ability to effectively communicate this information within their résumé. In other words, even the best-qualified candidate for a job can be overlooked if they submit a poorly written résumé.

In some situations, dozens of job seekers will submit their résumés for a single position. The increasing popularity of internet job boards such as Monster.com and Hotjobs.com has further increased the typical number of résumé submissions for a position into the hundreds.

At most, potential employers or recruiters reviewing the résumés for the position will spend only a few seconds on the initial review of each résumé to determine if the job seeker possesses any of the necessary qualifications for the job opening. If they do not immediately see the information they are looking for or if they find mistakes such as typographical errors or formatting problems, the résumé will often be immediately discarded.

Unfortunately, many job seekers are unaware of the shortcomings of their résumé. Currently, the best method for a job seeker to validate their résumé and understand its strengths and weaknesses is to enlist the help of a professional who possesses a good understanding of an effective résumé. However, these résumé professionals rarely begin reviewing résumé immediately and can sometimes take days. Further, their fees for the review service can be expensive, especially for a job seeker who has been unemployed for a particular length of time.

What is needed is a method of evaluating a job seeker's résumé that can provide feedback more quickly and with less expense than current résumé professionals.

### OBJECTS AND SUMMARY OF THE INVENTION

It is an object of the present invention to overcome the limitations of the prior art.

It is another object of the present invention to provide a method of more quickly evaluating résumés.

It is yet another object of the present invention to provide a method of evaluating résumés with less expense.

It is yet another object of the present invention to provide a method of evaluating résumés without the need for a person to review the contents of the résumé.

It is another object of the present invention to provide an automated résumé evaluation system.

In one preferred embodiment according to the present invention, an automated résumé evaluation system is provided which accepts résumés in an electronic file format, evaluates or validates those résumés according to a predetermined set of rules, then provides correspondence based on the outcome of the predetermined rules, which is sent back to the résumé submitter. Preferably, this predetermined set of rules is based on research, interviews, and surveys into the needs and desires of potential employers and recruiters.

### BRIEF DESCRIPTION OF THE DRAWINGS

FIG. 1 illustrates a flow chart of a preferred embodiment of an automated résumé evaluation method according to the present invention;

FIG. 2 illustrates a diagram of a preferred embodiment of a résumé evaluation system according to the present invention;

FIGS. 3A and 3B illustrate a flow chart of another preferred embodiment of an automated résumé evaluation method according to the present invention;

FIG. 4 illustrates a preferred embodiment of a résumé submission webpage according to the present invention;

FIG. 5 illustrates a résumé submitted in a preferred embodiment according to the present invention;

FIG. 6 illustrates a database entry created according to a preferred embodiment of the present invention; and

FIG. 7 illustrates a résumé evaluation correspondence created according to a preferred embodiment of the present invention.

### DETAILED DESCRIPTION OF THE INVENTION

The present invention provides an automated résumé evaluation system which automatically accepts an electronic résumé from a user, evaluates that résumé for problems, and then communicates those problems as well as related advice back to the user. In this respect, the user receives automated feedback on their résumé without the need for costly and time-consuming human analysis.

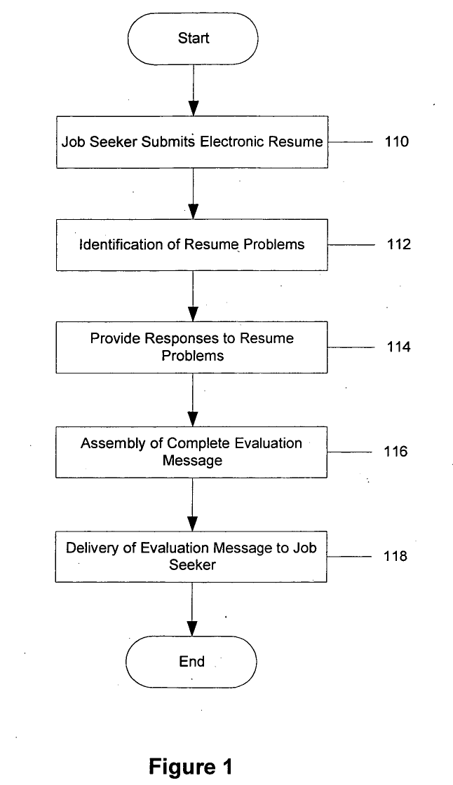

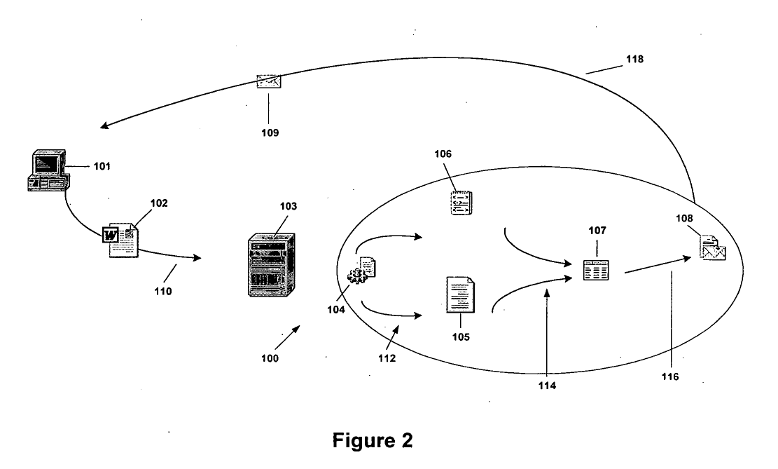

FIGS. 1 and 2 illustrate a preferred embodiment of an automated résumé evaluation system 100 according to the present invention which provides an automated evaluation of a submitted résumé without that résumé being reviewed by another person.

As shown in step 110, a job seeker submits an electronic résumé 102 from a computer 101 to a remote server 103 over a communications network such as the internet. Preferably, the electronic résumé 102 is in a commonly used electronic format such as a Microsoft Word document, a text rich document, a text document, or an HTML document. While the electronic résumé 102 is preferably sent by a commonly used communication format such as email, FTP, HTTP or instant message, other transfer methods are also contemplated, such as by floppy disk, CD, or USB flash drive.

Since the remote server 103 may accept a large number of résumés, each electronic résumé 102 is preferably assigned a unique filename. For example, the filename may consist of a number based on the date of submission and additional random digits (e.g. YYYYMMDDHHMMSS+6 random digits.DOC). This unique file name also facilitates associating additional information with the electronic résumé 102, such as the job seeker's name, email address, original résumé filename, submittal date, unique filename, demographic information, and technical information regarding the job seeker's experience.

Next, the electronic résumé 102 is analyzed for problems, as shown in step 112. While the analysis does not require that the electronic résumé 102 be converted to a specific electronic file format, such a conversion may decrease the complexity of the analysis program by reducing unnecessary data in the electronic document. This document simplification can therefore increase the reliability of the software to open and accurately analyze the contents of electronic résumé 102.

For example, FIG. 2 illustrates file format conversion 104 that converts the electronic résumé 102 into Plain ASCII Text format 106 and Rich Text Format 105. In this regard, one representation is created that only contains the underlying text of the original electronic résumé 102 and lacks any pictures, embedded document data, or formatting such as bold text, italic text, or line spacing. The other representation retains the formatting of the original electronic résumé 102 in the relatively simple Rich Text Format, thereby simplifying the task of identifying which formatting and markup characteristics are present. Thus, the representation 105 in Rich Text Format can be analyzed for problems relating to formatting while the representation 106 in Plain ASCII Text format can be analyzed for problems relating to the content of the text of the electronic résumé 102. Preferably, both representations 105 and 106 are preferably separate files, however additional configurations are possible, such as storing both representations 105 and 106 in a single file, such as within a database.

Once any desired file conversions are performed on the electronic résumé 102, the automated résumé evaluation system 100 searches the document or documents for predetermined characteristics. In other words, the electronic résumé 102 is compared against a predetermined group of résumé rules. Preferably, these characteristics or rules may relate to aspects of the electronic résumé 102 that positively or negatively impact the effectiveness of the job seeker's résumé in communicating necessary information to a potential employer. For example, issues relating to text content, formatting, layout, and file naming may be analyzed.

When a predetermined characteristic is found, a corresponding response is retrieved from a table of predetermined responses 107, as seen in step 114. These responses preferably offer commentary, criticism, and other tips relating to the identified predetermined characteristic. Both the afore-mentioned characteristics and responses are discussed in greater detail later in this specification.

As indicated by step 116, the predetermined responses from table 107 are assembled into an evaluation message 108 which is converted into a final message and delivered back to the job seeker as indicated in step 118. For example, the predetermined responses are preferably assembled in the form of a traditional letter format, addressed to the job seeker, then converted to an email message which is sent to the job seeker's email address. Alternately, the evaluation message 108 may be printed to paper and sent via U.S. Mail, or by an alternative delivery service. Additionally, the evaluation message 108 may be converted to a cellular phone text message and sent to the job seeker's phone. On the other hand, the evaluation message may also be presented on a web page.

In this respect, the automated résumé evaluation system 100 accepts a job seeker's electronic résumé 102, analyzes the résumé, then provides feedback on the electronic résumé 102 without human analysis.

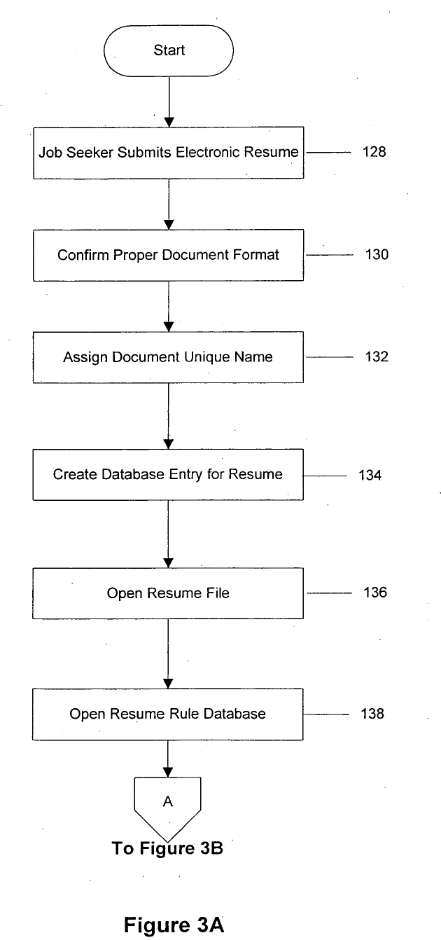

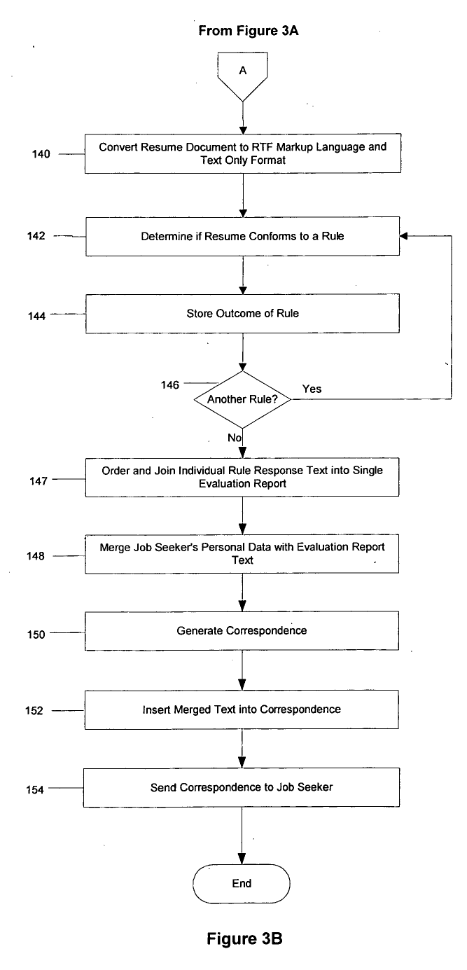

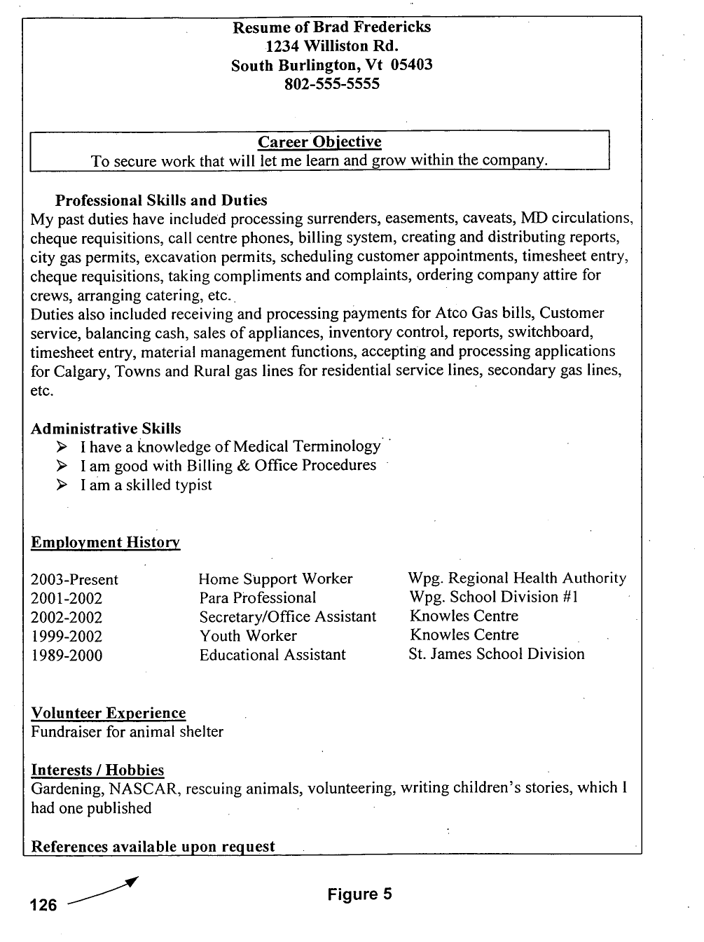

FIGS. 3A and 3B illustrate another preferred embodiment of an automatic résumé evaluation method according to the present invention. As indicated in step 128, the job seeker submits his or her electronic résumé 126, the example textual content of which can be seen in FIG. 5.

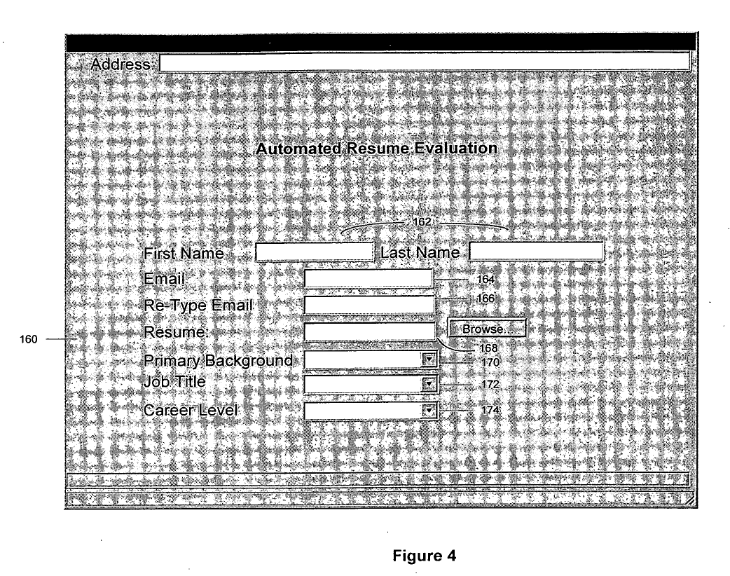

This submission is preferably facilitated by a résumé submission web page 160, which can be seen in FIG. 4. The résumé submission web page 160 is an electronic internet page that is programmed with such languages as Hyper Text Markup Language (HTML) or Active Server Pages, which can be viewed in a web browser.

The résumé submission web page 160 includes a résumé location text box 168 which provides a text box to manually input the location of the electronic résumé 126, such as on a hard drive of the job seeker's computer, or alternately browse to the location of the electronic résumé 126, causing the location to be automatically entered. In addition, the résumé submission web page 160 includes text boxes for providing additional data that may assist the résumé evaluation. For example, the job seeker's name is requested in text boxes 162, the job seeker's email is requested in text boxes 164 and 166. Additionally, the job seeker is requested to select a category in pull down box 170 that best describes their job background (e.g. administrative, medical, legal), their current job title in pull down box 172, and their current career level in pull down box 174. This additional information about the job seeker can be utilized during the evaluation to provide more accurate and relevant evaluation response. Alternatively, the résumé may be submitted via other mechanisms, such as by way of an email attachment or in the body of an email message.

Once the requested information has been provided on the résumé submission web page 160, the job seeker's information and electronic résumé 126 is uploaded to a remote server. As seen in step 130, a software module (i.e. a software program or part of a software program) examines the electronic résumé 126 to determine if it conforms to one of the document formats known to it, such as a Microsoft Word format or a Word Perfect format. For example, the type of document format may be determined by examining the extension of the document filename (i.e. “.doc”), or by examining the binary contents of the electronic file for known file format characteristics.

As described in step 132, the filename of the electronic résumé 126 is renamed to a unique file name. This is especially important since many job seekers may submit electronic résumés 126 with the same name, such as “résumé.doc”. To minimize the possibility of renaming the electronic résumé 126 to previously generated filename, the new résumé filename includes numbers derived from the year, month, day, hour, minute, and second of the submission of the electronic résumé 126 and further includes 6 additional randomly generated numbers. Thus, this naming scheme can facilitate handling a high number of electronic résumé submissions by ensuring that every submitted electronic résumé 126 will be assigned a unique filename.

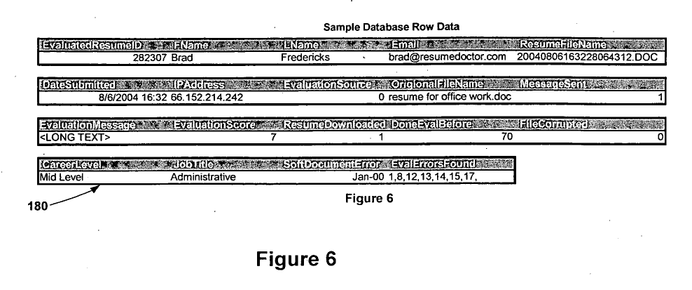

Additionally, as described in step 134, another software module creates an entry in a job seeker database to store data about the job seeker and the job seeker's electronic résumé 126. FIG. 6 illustrates a representation of an example database entry 180. This database entry 180 includes some of the job seeker's information submitted through the résumé submission web page 160, such as the job seeker's name, email address, original filename of the electronic résumé 126, career level, and job title. Additional information relevant to the submission is also included, such as the date submitted and the IP address of the computer from which the electronic résumé 126 was submitted. Further, as the résumé evaluation continues, evaluation data and evaluation messages can be stored in the database entry 180, which will be used to create a résumé evaluation message.

Step 136 of FIG. 3A describes how the electronic résumé 126 is opened. Typically, when a computer file, such as the electronic résumé 126, is “opened” by a software program, this includes loading the contents of the document into the memory of the computer where it can be accessed and manipulated by that software program.

As described in step 138, a résumé rule database is opened, allowing access to a plurality of rules relating to the formatting, layout, and textual content of a résumé. Preferably, these rules are created based on research, interviews, and surveys into the needs and frustrations of hiring and recruiting professionals. Specific examples of these résumés rules can be found further on in this specification.

Turning now to FIG. 3B, the electronic résumés 126 is converted into a Rich Text Format Markup Language and a Text Only Format, as indicated in step 140. As previously described, conversion into a Rich Text Format Markup Language allows the document to be easily compared to a rule related to formatting and layout while conversion into a Text Only Format allows the document to be easily compared against a rule relating to the text content.

As step 142 indicates, a first rule from the résumé rule database is selected and compared to the appropriate version of the converted electronic résumés 126 (i.e. the electronic résumé 126 in Text Only Format or the in Rich Text Format). For example, one rule might search for the use of graphics or pictures within the electronic résumé 126. The outcome to this rule, as seen in step 144, is stored in the previously described entry 180 in the job seeker database of FIG. 6 for later use in constructing an evaluation message.

Once the outcome of the résumé rule is recorded in the job seeker database, the software module on the server determines if additional résumé rules are present in the résumé rule database, as seen in step 146. If an additional résumé rule is present, steps 142 and 144 are repeated until all résumé rules have been compared against the electronic résumé 126.

Each résumé rule is associated with one or more rule responses, preferably within the same résumé rule database, which provides feedback, criticism, or other comments. In some cases, only a single rule response is desired for a particular rule. For example, a résumé rule that looks for the undesirable presence of a table within the electronic résumé 126 may only require a rule response when such a table is present, but does not necessarily require a response when a table is not present. In other cases, multiple rule response may be desired for a particular rule. For example, a résumé rule that looks for an email address within the electronic résumé 126 may include one response commending when the email address is included, and another response highlighting the need to include an email address when the email address is not included.

Next, as indicated in step 146, the rule responses determined for a particular electronic résumé 126 are joined together in a single temporary electronic representation (e.g. data within memory or text stored within a database entry). Preferably, these rule responses are arranged in a desired order, enhancing the flow and logical progression. For example, the responses relating to formatting of the electronic résumé 126 can be presented first, while content related comments can be arranged to follow.

Next, selected personal data from the database entry 180 in the job seeker database is integrated into the temporary electronic representation. For example, the job seeker's name may be added as a salutation within the temporary electronic document.

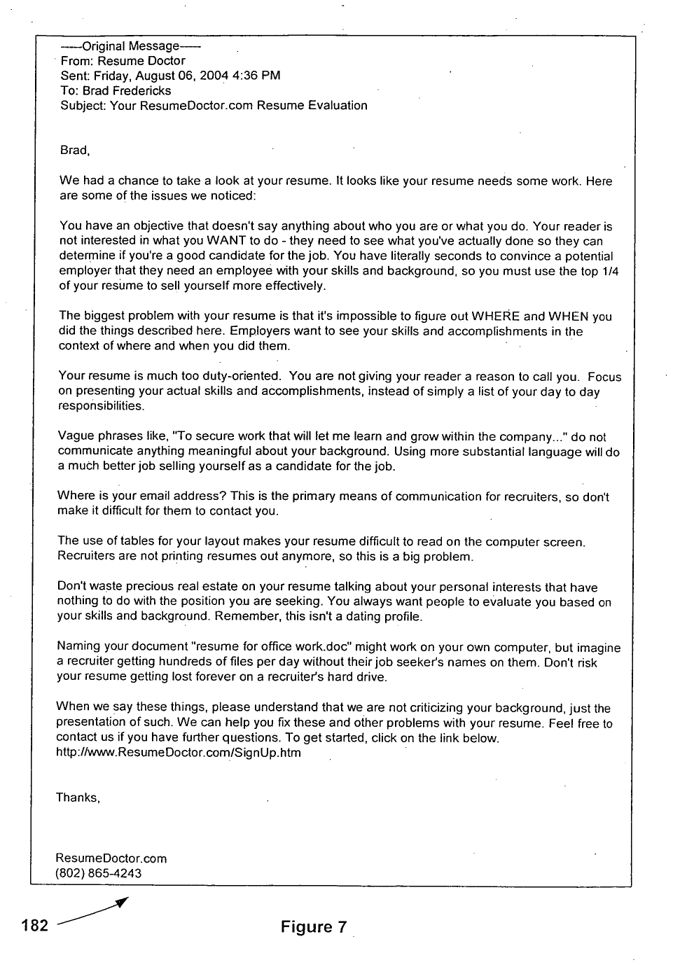

As presented in step 150, a correspondence is generated that will be sent to the job seeker. This correspondence can be a blank email addressed to the job seeker, a text document that will be printed and sent by U.S. Mail, or a message that appears in a job seeker's web browser. The text of the temporary representation, i.e. the ordered rule responses and the integrated personal information are then copied into the correspondence document, as indicated in step 152. FIG. 7 illustrates such an email correspondence 182 which includes the text of the temporary document. Finally, as indicated in step 154, the email correspondence 182 is delivered or communicated to the job seeker. In this respect, the job seeker receives the email correspondence 182 which includes feedback (i.e. rule responses) to their electronic résumé 126 without the need for human review of the electronic résumé 126.

As previously discussed in this specification, predetermined résumé rules are automatically compared against a job seeker's résumé and the results of the résumé rule are used to select appropriate response to send back to the job seeker. Preferably, the résumé rules of a preferred embodiment of the résumé evaluation system apply conditional logic to the text, formatting and markup codes contained within the electronic résumé of the job seeker. Preferably, this conditional logic utilizes keyword searches and regular expression searches of the text and underlying formatting codes. Based on the positive or negative outcome of the keyword searches, it can be extrapolated that the electronic résumé either conforms with or violates one of the résumé rules. For example, if the electronic résumé contains the word “Objective” in the top ¼ of the résumé text, it can be assumed that the electronic résumé contains a “Career Objective”, which is undesirable to most recruiters and employers.

Some résumé rules utilize regular expression searching to model the syntax of the English language and therefore adapt to the many grammatical structures used in sentences. More specifically, regular expression searching typically utilizes symbols and syntax to match patterns in text. In this respect, a greater number of problematic sentences can be identified by including at least some grammatical structure within the search queries. An asterisk is commonly used with many search engines in this regard, for example letting a user search their computer for all word document by searching with the phrase “*.doc”.

In one example, vague sentences can be identified by creating a regular expression search, as seen in the sample Visual Basic code below. As seen, phrases such as “To find a meaningful job,” “To secure a great job,” and “To seek employment with a growth oriented company” would all be identified by this search and further, incorporated into the résumé rule response.

### CODE EXAMPLE 1

```
Private Function FindVagueSentence(ByVal VagueSentenceText As String) As String
Dim RegExp As RegExp, RTFMatches As MatchCollection, RTFMatch As Match
Dim VerbA1 As String, NounA1 As String, VerbB1 As String
  ‘ top 1/4 of résumé
  VagueSentenceText = Left(VagueSentenceText, (Len(VagueSentenceText) / 4))
  ‘ Dictionary of Verbs found a the begining of these vague sentences
  VerbA1 = VerbA1 & “work” & “|”
  VerbA1 = VerbA1 & “contribute” & “|”
  VerbA1 = VerbA1 & “use” & “|”
  VerbA1 = VerbA1 & “obtain” & “|”
  VerbA1 = VerbA1 & “acquire” & “|”
  VerbA1 = VerbA1 & “seek” & “|”
  VerbA1 = VerbA1 & “find” & “|”
  VerbA1 = VerbA1 & “further” & “|”
  VerbA1 = VerbA1 & “secure” & “|”
  VerbA1 = VerbA1 & “utilize” & “|”
  VerbA1 = VerbA1 & “expand” & “|”
  VerbA1 = VerbA1 & “maximize” & “|”
  VerbA1 = VerbA1 & “advance” & “|”
  VerbA1 = VerbA1 & “build” & “|”
  VerbA1 = VerbA1 & “drive” & “|”
  VerbA1 = VerbA1 & “train” & “|”
  VerbA1 = VerbA1 & “gain” & “|”
  VerbA1 = VerbA1 & “succeed” & “|”
  VerbA1 = VerbA1 & “progress” & “|”
  VerbA1 = VerbA1 & “provide” & “|”
  VerbA1 = VerbA1 & “accomplish” & “|”
  VerbA1 = VerbA1 & “join” & “|”
  VerbA1 = VerbA1 & “perform” & “|”
  VerbA1 = VerbA1 & “improve” & “|”
  VerbA1 = VerbA1 & “ensure” & “|”
  VerbA1 = VerbA1 & “give” & “|”
  VerbA1 = VerbA1 & “begin” & “|”
  VerbA1 = VerbA1 & “service” ‘ Last on can't have “|”
    NounA1 = NounA1 & “position” & “|”
  NounA1 = NounA1 & “advancement” & “|”
  NounA1 = NounA1 & “field” & “|”
  NounA1 = NounA1 & “career” & “|”
  NounA1 = NounA1 & “job” & “|”
  NounA1 = NounA1 & “employment” & “|”
  NounA1 = NounA1 & “company” & “|”
  NounA1 = NounA1 & “organization” & “|”
  NounA1 = NounA1 & “environment” & “|”
  NounA1 = NounA1 & “experience” & “|”
  NounA1 = NounA1 & “expertise” & “|”
  NounA1 = NounA1 & “career” & “|”
  NounA1 = NounA1 & “atmosphere” & “|”
  NounA1 = NounA1 & “commitment” & “|”
  NounA1 = NounA1 & “goal” & “|”
  NounA1 = NounA1 & “industry” & “|”
  NounA1 = NounA1 & “profession” & “|”
  NounA1 = NounA1 & “responsibility” & “|”
  NounA1 = NounA1 & “growth” & “|”
  NounA1 = NounA1 & “management” & “|”
  NounA1 = NounA1 & “background” & “|”
  NounA1 = NounA1 & “knowledge” ‘ Last on can't have “|”
  Set RegExp = CreateObject(“VBScript.RegExp”)
  RegExp.Global = True
  RegExp.IgnoreCase = True
  RegExp.MultiLine = True
  ‘ 1st Vague sentence syntax
  RegExp.Pattern = “To\s?(“ & VerbA1 & ”) [\S\x20]{10,120}?(“ & NounA1 & ”)”
  Set RTFMatches = RegExp.Execute(VagueSentenceText)
  If RTFMatches.Count > 0 Then
    FindVagueSentence = RTFMatches.Item(0).Value
  End If
  If FindVagueSentence <> “” Then Exit Function
  ‘ Matches without the word “To” run into problems with words
  ‘like “work” and “use” - this could describe work experience
  VerbB1 = VerbB1 & “contribute” & “|”
  VerbB1 = VerbB1 & “obtain” & “|”
  VerbB1 = VerbB1 & “acquire” & “|”
  VerbB1 = VerbB1 & “seek” & “|”
  VerbB1 = VerbB1 & “further” & “|”
  VerbB1 = VerbB1 & “secure” & “|”
  VerbB1 = VerbB1 & “utilize” & “|”
  VerbB1 = VerbB1 & “expand” & “|”
  VerbB1 = VerbB1 & “advance” & “|”
  VerbB1 = VerbB1 & “gain” & “|”
  VerbB1 = VerbB1 & “succeed” & “|”
  VerbB1 = VerbB1 & “progress” & “|”
  VerbB1 = VerbB1 & “provide” & “|”
  VerbB1 = VerbB1 & “accomplish” & “|”
  VerbB1 = VerbB1 & “join” & “|”
  VerbB1 = VerbB1 & “perform” & “|”
  VerbB1 = VerbB1 & “improve” ‘ Last on can't have “|”
  ‘ 2nd Vague sentence syntax
  RegExp.Pattern = “\b(“ & VerbB1 & ”) [\S\x20]{15,120}?(“ & NounA1 & ”)”
  Set RTFMatches = RegExp.Execute(VagueSentenceText)
  If RTFMatches.Count > 0 Then
    FindVagueSentence = RTFMatches.Item(0).Value
  End If
    If FindVagueSentence <> “” Then Exit Function
  ‘ 3rd Vague sentence syntax
    RegExp.Pattern =
  “Seeking[\S\x20]{1,30}(career|position|work)[\S\x20]{30,120}(advancement|skills|experience|
  expertise)”
    Set RTFMatches = RegExp.Execute(VagueSentenceText)
    If RTFMatches.Count > 0 Then
      FindVagueSentence = RTFMatches.Item(0).Value
    End If
    If FindVagueSentence <> “” Then Exit Function
    ‘ 4th Vague sentence syntax
    RegExp.Pattern = “a
  position[\S\x20]{5,40}(career|position|work)[\S\x20]{15,120}(advancement|skills|experience|
  expertise)”
    Set RTFMatches = RegExp.Execute(VagueSentenceText)
    If RTFMatches.Count > 0 Then
      FindVagueSentence = RTFMatches.Item(0).Value
    End If
    If FindVagueSentence <> “” Then Exit Function
  End Function
    If VagueSentence = True Then
      EvaluateRésumé = EvaluateRésumé & “Vague phrases like, ““” &
  VagueSentenceString & “...”” do not communicate anything meaningful about your
  background. Using more substantial language will do a much better job selling yourself as
  a candidate for the job.” & Chr(10) & Chr(10)
    End If
```

### EXAMPLE RÉSUMÉ RULES

To further illustrate the résumé rules of the preferred embodiment described in this specification, sample résumé rules and the corresponding résumé rule responses are provided in Table 1 below. It should be understood that these example résumé rules can be coded as many different queries or expressions in a variety of different programming or scripting languages as is known in the art.

TABLE 1

| Résumé Rule Name | Description | Résumé Rule Response |
|---|---|---|
| Uses Tables or Textboxes | Electronic Résumés should | “for your layout makes your |
| For Layout | not use tables to layout text. | résumé difficult to read on |
| | This rule searches the | the computer screen. |
| | markup code of the | Recruiters are not printing |
| | document for the specific | résumés out anymore, so |
| | formatting commands that | this is a big problem.” |
| | create these elements. | |
| Has Graphics and Pictures | Graphics and pictures in | “It's very frustrating for hiring |
| | résumés inflate the file size | managers to read and |
| | unnecessarily, cause | manage résumés when they |
| | technical problems when | have graphical lines and |
| | trying to post the document | pictures on them. This can |
| | online or in a database, and | also cause a problem when |
| | are unprofessional. This rule | you paste your résumé on a |
| | searches the markup code of | job board or even when the |
| | the document for the specific | résumé is archived in an |
| | formatting commands that | employer's database.” |
| | indicate the presence of | |
| | pictures. | |
| Long and Dense Paragraphs | A résumé must be clear and | “Your résumé is too dense. |
| | concise. Long and dense | Long paragraphs are hard to |
| | paragraphs are unlikely to be | read, making it difficult for |
| | read by a hiring professional. | your reader to skim your |
| | This rule parses out each | résumé. Also, this makes it |
| | paragraph in the document | impossible to customize your |
| | and checks to see if the | résumé to each job posting |
| | number of characters used | you send it to. Keep in mind |
| | in the paragraph exceeds | that recruiters and hiring |
| | the defined threshold. | managers have only 5 to 10 |
| | | seconds to devote to each of |
| | | the hundreds of résumés |
| | | they get each day, so it is |
| | | imperative that you use |
| | | concise bullet-point phrases |
| | | to communicate to your |
| | | reader.” |
| Long Résumé | Hiring professionals greatly | “Recruiters receive hundreds |
| | dislike long résumés. This | of résumés for each job |
| | rule evaluates the document | posting, so they don't have |
| | page length, determined | time to read a few pages of |
| | during the document RTF | text just to figure out your |
| | conversion process, and | background. Try to keep it |
| | checks to see if the length | to two pages.” |
| | exceeds 3 pages. This rule | |
| | also considers a document | |
| | too long when it exceeds a | |
| | specified number of | |
| | characters used. | |
| Résumé Contains Vague | A résuméshould not contain | Vague phrases like, |
| Phrases | vague and meaningless | [Example Sentence 1] do not |
| | phrases - it need to stick to | communicate anything |
| | the facts about a jobseeker's | meaningful about your |
| | tangible skills, | background. Using more |
| | accomplishments, and | substantial language will do |
| | background. This rule | a much better job selling |
| | determines if the résumé | yourself as a candidate for |
| | contains vague phrases by | the job.” |
| | identifying a common type of | |
| | vague phrase used in the top | |
| | ¼ of many résumés. | |
| Vague Language | A recent study shows that | “Words like [Example |
| | over half of all résumés | Words] are too generic and |
| | contain vague and imprecise | could be applied to nearly |
| | language. A résumé must | any job seeker out there. |
| | stick to the tangible facts | You would be much better |
| | about a jobseeker's skills, | off by getting right to the |
| | accomplishments, and | point and presenting your |
| | background. The following | skills and accomplishments, |
| | rule contains a dictionary of | because this type of |
| | commonly used vague | language will not sell you as |
| | language and performs a | a candidate for the job.” |
| | keyword search to determine | |
| | whether any of the keywords | |
| | are found. In the evaluation | |
| | response, the system cites | |
| | up to three of the vague | |
| | keywords found. | |
| First Person References in | A résumé is a formal | “First person references |
| Résumé | business communications | make your résumé much |
| | and should not contain any | more verbose than |
| | first person references, such | necessary. It's best to avoid |
| | as “I am,” “I was,” “I have,” | using words like ““I am ...”” |
| | etc. This rule performs a | and ““I was ...”” because you |
| | regular expression search | don't want your résumé to |
| | for first person references. | become a ““what I did last |
| | The rule also performs a | summer essay.””” |
| | keyword search for words | |
| | and phrases commonly | |
| | found in a cover letter. | |
| | Occasionally, job seekers | |
| | include a cover letter, in | |
| | which first person references | |
| | are acceptable, within the | |
| | same document as their | |
| | résumé. When a cover letter | |
| | is suspected, the appropriate | |
| | evaluation response is not | |
| | triggered. | |
| Poor Filename Choice | In a recent study, over half of | “Naming your document |
| | all résumé documents were | [Résumé Filename] might |
| | found to be named some | work on your own computer, |
| | minor variation of | but imagine a recruiter |
| | “Résumé.doc.” The problem | getting hundreds of files per |
| | is that recruiters and hiring | day without their job seeker's |
| | professionals receive | names on them. Don't risk |
| | hundreds of résumés per | your résumé getting lost |
| | day, creating numerous | forever on a recruiter's hard |
| | problems when they all have | drive.” |
| | similar names. The best | |
| | advise is to put your full | |
| | name in the document | |
| | name. This rule performs a | |
| | regular expression search on | |
| | the document filename to | |
| | determine if it contains a | |
| | minor variation of | |
| | “Résumé.doc,” such as “My | |
| | Résumé.doc” or | |
| | “Résumé2.doc.” If that | |
| | search returns nothing, then | |
| | the rule next checks to see if | |
| | the job seeker's last name is | |
| | contained in the document | |
| | filename. | |
| Résumé format based on | Occasionally, job seekers | “The biggest problem with |
| skill function, instead of | organize their résumé | your résumé is that it's |
| Chronological format | according to job or skill | impossible to figure out |
| | function, instead of the | WHERE and WHEN you did |
| | traditional reverse | the things described here. |
| | chronological format. Hiring | Employers want to see your |
| | professionals greatly dislike | skills and accomplishments |
| | the functional format, | in the context of where and |
| | because it makes it | when you did them.” |
| | impossible to see those skills | |
| | and accomplishments in the | |
| | context of where and when | |
| | they were performed. | |
| Résumé doesn't contain the | Email is the primary | “Where is your email |
| job seeker's Email address | communication tool for most | address? This is the primary |
| | recruiters. All electronic | means of communication for |
| | résumé documents must | recruiters, so don't make it |
| | have an email address. This | difficult for them to contact |
| | rule performs a keyword | you.” |
| | search for the “@” character | |
| | which must be present in all | |
| | email addresses. If the “@” | |
| | character is found, then it is | |
| | assumed that the résumé | |
| | does contain an email | |
| | address. | |
| Résumé Contains Hobbies/ | Personal hobbies and | “Don't waste precious real |
| Interests | interests do not belong on a | estate on your résumé |
| | résumé, yet a recent study | talking about your personal |
| | shows that over 20% of | interests that have nothing to |
| | résumés contain them. This | do with the position you are |
| | rule performs a keyword | seeking. You always want |
| | search in the lower ⅓ of the | people to evaluate you |
| | résumé for a section entitled | based on your skills and |
| | “hobbies” or “interests.” If | background. Remember, |
| | those keywords are not | this isn't a dating profile.” |
| | found, the rule then performs | |
| | a keywords search in the | |
| | lower ⅓ of the document | |
| | for common hobbies, such | |
| | as “golf” or “skiing.” | |
| Résumé Contains Personal | Résumés should not contain | “Personal information about |
| Information | personal information, as it is | yourself or your family |
| | seldom appropriate in a job | should not be on your |
| | search. This rule searches | résumé. Personal info can |
| | for references to personal | only hurt you and has no |
| | information, such as “my | place on a résumé.” |
| | family” or “date of birth.” It | |
| | also performs a regular | |
| | expression search for a | |
| | series of numbers matching | |
| | a social security number | |
| | (\d\d\d-\d\d-\d\d\d\d). | |
| Résumé Contains a Career | A résumé should always | “You have an objective that |
| Objective | focus on addressing what a | doesn't say anything about |
| | particular employer is | who you are or what you do. |
| | looking for in a candidate. | Your reader is not interested |
| | However, traditionally, job | in what you WANT to do — |
| | seekers begin their résumé | they need to see what |
| | with a statement of their | you've actually done so they |
| | “career objectives,” which | can determine if you're a |
| | has very little interest to | good candidate for the job. |
| | hiring professionals. This | You have literally seconds to |
| | rule performs a keyword | convince a potential |
| | search in the top ⅓ of the | employer that they need an |
| | résumé for the word | employee with your skills |
| | “objective.” If this word is | and background, so you |
| | found, the rule assumes that | must use the top ¼ of your |
| | what follows the word | résumé to sell yourself more |
| | “objective” is the job seeker's | effectively.” |
| | career objective. | |
| Résumé Was Pasted From | Some job seekers paste | “It looks like you are using a |
| Monster.com | their résumé template from | Monster résumé template. |
| | the web site of Monster.com | This is a poorly designed |
| | into a word processing | résumé format. Recruiters |
| | document. The | and hiring managers find |
| | monster.com template | these difficult to read and will |
| | format has many | always ask you for a better |
| | shortcomings, not to mention | version of your résumé.” |
| | the formatting issues that | |
| | occur when pasting from a | |
| | web page into a document. | |
| | This rule performs a keyword | |
| | search for words and | |
| | phrases that could suggest | |
| | that this is a Monster.com | |
| | résumé template. | |
| | Monster.com templates also | |
| | contain graphical elements, | |
| | so if the rule determines that | |
| | it is a Monster.com template, | |
| | it suppresses the rule | |
| | pertaining to graphics in | |
| | résumés. | |
| A Microsoft Word Résumé | Several common résumé | “Your contact info is poorly |
| Template was used | templates are available in | presented. This is a very |
| | Microsoft Word. Each of | important part of you |
| | these present their own | résumé, so make it easy to |
| | unique formatting and layout | find and read on the |
| | issues that cause problems | computer screen.” |
| | for hiring professionals, such | |
| | as poor fonts, tables, and | |
| | text boxes. This rule | |
| | performs a search of the | |
| | document's rich text markup | |
| | text identify if one of these | |
| | templates was used. | |
| | Depending upon which | |
| | template is found, the rule | |
| | can infer that the associated | |
| | problems are present in the | |
| | résumé, such as poor | |
| | presentation of contact info | |
| | or poor font choice. | |
| Résumé is too Duty | A great résumé should focus | “Your résumé is much too |
| Oriented, instead of focusing | on your skills and | duty-oriented. You are not |
| on actual skills and | accomplishments at your | giving your reader a reason |
| accomplishments. | previous positions, instead of | to call you. Focus on |
| | merely presenting a | presenting your actual skills |
| | repetitive list of your actual | and accomplishments, |
| | duties at those jobs. This | instead of simply a list of |
| | rule looks for a combination | your day to day |
| | of particular keywords that | responsibilities.” |
| | are usually present when the | |
| | résumé is considered “too | |
| | duty oriented.” | |
| Misleading or imprecise | When describing recent | “Listing [Date 1]-[Date 2] is |
| Dates for short Date spans | previous employment of | not specific enough, as it |
| | short durations, it is | could potentially mean [Date |
| | necessary to include the | 3]-[Date 4] Be sure to |
| | months of employment along | specify months of |
| | with the years, as 2001-2002 | employment for a short span |
| | could potentially mean | of time such as this.” |
| | December 2001-January 2002. | |
| | This rule performs a regular | |
| | expression search to locate | |
| | dates that are likely to be | |
| | dates of employment. It then | |
| | calculates whether the year | |
| | and duration of the | |
| | employment meet the criteria | |
| | for triggering this error. | |
| Résumé states “References | Hiring professionals already | “You do not need to state |
| available on request” | assume that anyone looking | ““References Available Upon |
| | for a job could produce | Request,”” as all job seekers |
| | professional references if | are expected to have |
| | requested. This rule | references. There is no |
| | performs a regular | need to discuss your |
| | expression search that | references until they are |
| | locates variations of the | specifically requested from |
| | phrase “References | you.” |
| | available on request.” | |
| Résumé Has Actual Names | It is never advisable for job | “There is no need to list your |
| and Telephone Numbers of | seekers to include the | references on your résumé. |
| Employment References | names and telephone | You don't want a potential |
| | numbers of professional and | employer to call them before |
| | personal references in a | you have interviewed with |
| | résumé before they are | the company. You need to |
| | requested. This rule | be able to tell your |
| | attempts to identify a section | references to expect a |
| | of the résumé entitled | particular employer to give |
| | “References,” then performs | them a call.” |
| | regular expression searches | |
| | to see if names and | |
| | telephone numbers are listed | |
| | in that section. | |
| Résumé lists very old | Hiring professionals are | “There is no need to go into |
| Employment in detail | primarily interested in recent | detail about older |
| | employment on a résumé, | employment. It's only the |
| | meaning anything within the | last 5-10 years that an |
| | last 5 to 10 years. This rule | employer wants to see on a |
| | identifies the previous | résumé. The want to know |
| | employers listed on the | what you've been doing |
| | résumé, evaluates the last | lately.” |
| | date the job seeker was | |
| | employed there, and | |
| | evaluates how much | |
| | descriptive text the job | |
| | seeker wrote under this | |
| | employer. | |
| Password Protected | Occasionally, job seekers | “This document is password |
| Document | inadvertently submit | protected. Recruiters get |
| | documents that are | hundreds of résumés per |
| | password protected. This | day - don't expect them to |
| | rule determines if the | tell you that they can't open |
| | document is password | your document. Please |
| | protected based upon errors | send us a file that we can |
| | that are generated during the | open.” |
| | rich text conversion process. | |

In an alternative preferred embodiment according to the present invention, a process similar to those described above may be performed on a user's computer by downloading a program (such as a program in the Java programming language) from a web server. In this respect, the evaluation of the user's résumé can be performed directly on the user's computer. Further, the eésumé evaluation software can be installed by CD, DVD, or other disk on the user's computer, allowing the user to similarly evaluate a eésumé on their personal computer. By installing the eésumé software on the user's computer, the user may also perform multiple eésumé evaluations, such as in automatically processed batches. This batch processing may be especially desired for a business that charges for eésumé evaluations.

While the preferred embodiments described in this specification have been mostly described in terms of providing an overall evaluation of a eésumé, the present invention may also be used to evaluate or validate a single criteria and generate a response based on the outcome of that rule. For example, a single eésumé rule can be used to evaluate or validate an electronic eésumé file uploaded to a server through a website. This server may apply, for example, a eésumé rule that searches the electronic eésumé for dates of employment. If no dates are present, if the dates are vague or are in a difficult to read format, a message can be sent back to the user indicating that their employment dates are not present or are not in a standard format.

At times in this specification, the preferred embodiments have been described in terms of steps, especially in relation to the flow charts of the Figures. However, this language should not be interpreted to necessarily limit an order in which these steps must occur. For example, the step 132 of assigning a unique filename to the electronic eésumé 126 may occur after step 134 in which a database entry for the electronic eésumé 126 is created.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A method for automatically evaluating a eésumé comprising:
providing an electronic resume;
providing a plurality of eésumé rules;
comparing said electronic eésumé against a single eésumé rule of said plurality of eésumé rules and determining an outcome; and
providing an evaluation response based on said outcome.

2. The method of claim 1, wherein said providing an electronic eésumé includes emailing said electronic eésumé to a remote computer.

3. The method of claim 1, wherein said providing an evaluation response includes providing said evaluation response within a correspondence.

4. The method of claim 3, further comprising delivering said correspondence to a predetermined location.

5. The method of claim 4, wherein said delivering said correspondence is selected from a group comprising: sending an email, delivering a web page, delivering a text message, and delivering a printed letter.

6. The method of claim 1, wherein said plurality of eésumé rules include conditional logic eésumé rules.

7. The method of claim 1, wherein said plurality of eésumé rules include regular expression searching eésumé rules.

8. The method of claim 1, wherein at least a portion of said plurality of rules are configured to evaluate a eésumé characteristic and wherein said eésumé characteristic is selected from a group consisting of: use of tables, use of textboxes, use of graphics, use of pictures, use of long and dense paragraphs, use of a long résumé, use of vague phrases, use of vague language, use of first person references, use of a poor filename, use of chronological format, use of an email address, use of hobbies, use of personal information, use of a career objective, use of eésumé templates, use of imprecise dates, use of misleading dates, use of the phrase “references available on request”, use of contact information of references, use of old employment information, and use of password protection.

9. A computerized system for evaluation an electronic eésumé without review by a person, said résumé evaluation system comprising:
an electronic storage device configured to store a plurality of eésumé rules, a plurality of evaluation responses, and said electronic résumé;
an input device configured to accept said electronic eésumé and storing said electronic eésumé on said electronic storage device;
a processor configured to communicate with said electronic storage device, to compare at least one of said plurality of eésumé rules with said electronic résumé, and to provide at least one evaluation response from said plurality of evaluation responses, said at least one evaluation response being based on an outcome of said at least one of said plurality of eésumé rules; and
an output device for communicating said at least one evaluation response from said plurality of evaluation responses to a person.

10. The computerized system of claim 9, wherein said electronic storage device is a hard drive.

11. The computerized system of claim 9, wherein said input device is a network card.

12. The computerized system of claim 9 wherein said evaluation response is selected from a group comprising: an email, a web page, a cell phone text message, and a printed letter.

13. A method for evaluating an electronic eésumé without review of said electronic eésumé by a person, said method comprising:
accepting an electronic résumé;
providing a plurality eésumé queries;
providing a plurality of comments;
selecting a first eésumé query from said plurality of eésumé queries;
executing said first eésumé query on said electronic eésumé and recording an outcome of said first eésumé query;
selecting a first comment from said plurality of comments that is based on said outcome of said first eésumé query; and
communicating said first comment to a person.

14. The method of claim 13, wherein said plurality of eésumé queries are configured to evaluate the effectiveness of an electronic résumé.

15. The method of claim 13, wherein selecting a first comment from said plurality of comments that is based on said outcome of said first eésumé query is followed by:
selecting a second eésumé query from said plurality of eésumé queries;
executing said second eésumé query on said electronic eésumé and recording an outcome of said second eésumé query;
selecting a second comment from said plurality of comments that is based on said outcome of said second eésumé query; and
communicating said second comment to said person.

16. The method of claim 13, wherein said accepting an electronic eésumé includes receiving an electronic eésumé by email and storing said electronic eésumé on an electronic storage device.

17. The method of claim 13, wherein said eésumé queries are stored in a database within an electronic information storage device.

18. The method of claim 13, wherein said communicating said first comment to a person includes copying said first comment into a correspondence.

19. The method of claim 18, further comprising obtaining personal information from said person and incorporating said personal information into said correspondence.

20. The method of claim 13, wherein said accepting an electronic eésumé includes navigating to a webpage and uploading said electronic eésumé to a remote server.
